(19) United States
(12) Patent Application Publication
(10) Pub. No.: US 2014/0236709 A1
(43) Pub. Date: Aug. 21, 2014

(54) TECHNIQUES FOR ADVERTISING

(71) Applicant: NCR CORPORATION, Duluth, GA (US)

(72) Inventors: Joseph Luis Aguayo, Chandler, AZ (US); Timothy Mark Heffernan, Babylon, NY (US)

(73) Assignee: NCR Corporation, Duluth, GA (US)

(21) Appl. No.: 13/769,305

(22) Filed: Feb. 16, 2013

(51) Int. Cl. G06Q 30/02

(52) U.S. Cl. CPC G06Q 30/0241
USPC 705/14.44; 705/347; 705/26.9

(57) ABSTRACT

Techniques for advertising are provided. A mobile device is synchronized with a media feed playing on a separate device and metadata for products and services related to the media feed are presented on the mobile device. A user makes comments on selective products and services and actions are performed on the mobile device to assist the user in one or more of: acquiring additional information for the selected products and services, scheduling a time to try out the selected products and services, and purchasing and/or picking up the selected products and services.

### BACKGROUND

Television viewers are increasingly using technology to skip commercials; thereby decoupling advertising viewing from content and threatening the television networks' long-standing business models on traditional advertising. For as long as television has existed, the business model of the networks has been: buy/develop content to sell commercial time slots to advertisers, and derive profits (or losses) based on viewership ratings. However, as more and more viewers use Digital Video Recorders (DVR) to time-shift viewing and/or use video streaming services such a Netflix™ to skip commercials, the traditional television network model is under assault. While the use of product placement has had some success in getting products in front of viewers, converting eyeballs into purchases remains as elusive as ever even with the many advancements in technology.

Some enterprises are taking product placement to another level by pushing offers to viewers via their mobile devices and personal computers. The services use a show's audio track to synchronize the viewer's mobile device and to push offers to the mobile devices. Some services require viewers to click or touch the items they are interested in to obtain offers. Both solutions require integration with the show.

Integration of these services is spotty at best and limited to specific content and specific DVR-based devices. Moreover, the actions and information available and how that information is presented are severely circumscribed by the present services available in the industry. As a result, these services have not assisted the televisions networks in any significant manner in revising their business models with respect to revenues and advertisers continue to evaluate the efficacy associated with their use of network-based advertising.

### SUMMARY

In various embodiments, techniques for advertising are presented. According to an embodiment, a method for interactive advertising is provided.

Specifically, a media feed is synchronized to a mobile device; the media feed playing on a second device. Next, metadata is displayed on the mobile device tied to the media feed; the metadata associated with products or services tied to the media feed. Finally, comments received from a user with respect to one or more of the products or the services are recorded.

### BRIEF DESCRIPTION OF THE DRAWINGS

FIG. 1 is a diagram of a method for advertising, according to an example embodiment.

FIG. 2 is a diagram of another method for advertising, according to an example embodiment.

FIG. 3 is a diagram of yet another method for advertising, according to an example embodiment.

FIG. 4 is a diagram of an interactive advertising system, according to an example embodiment.

### DETAILED DESCRIPTION

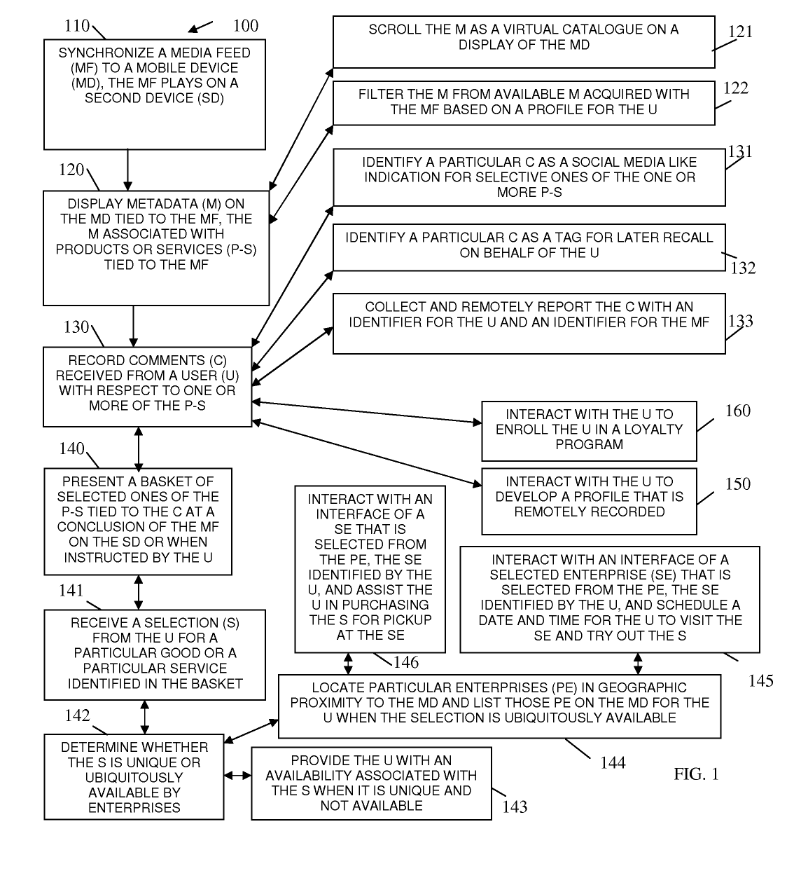

FIG. 1 is a diagram of a method 100 for advertising, according to an example embodiment. The method 100 (hereinafter “advertising mobile app”) is implemented as instructions programmed and residing in memory and/or on a non-transitory computer-readable (processor-readable) storage medium and executed by one or more processors. The processors are specifically configured and programmed to process the advertising mobile app. The advertising mobile app operates over a network. In an embodiment, the network is wireless.

In an embodiment, the advertising mobile app executes on processors of a mobile device. The mobile device can be a phone, a table, a laptop, a wearable device, and the like. The mobile device is operated by a user.

At 110, the advertising mobile app is synchronized with a media feed that is playing on a different device (second device). That is, the advertising mobile app processes on a mobile device of the consumer (tablet, phone, laptop, wearable device, etc.) and the advertising mobile app synchronizes with the playing of the media feed occurring on the second device. So, what is displaying on the mobile device of the consumer (may also be referred to herein as user) is time synched with what is displaying on the second device (second device) that is playing the media feed.

As used herein the phrase “media feed” refers to video, presentations, and/or combinations of multimedia (graphics, images, photos, video, text, animations, audio, etc.) for content. The media feed plays on the second device (television, digital sign, different mobile device from the one associated with the consumer/user, etc.).

In an embodiment, a third-party service is used for synchronizing the advertising mobile app on the mobile device with the playing of the media feed on the second device.

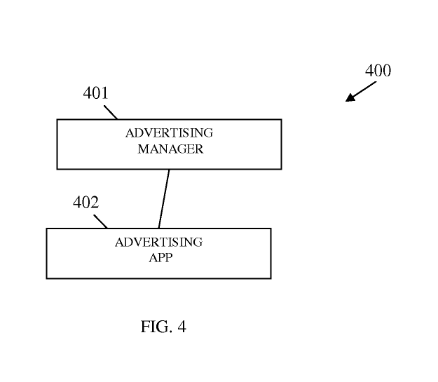

At 120, the advertising mobile app displays metadata on the mobile device that is tied to the media feed. The metadata associated with one or more products or services tied in some manner to the media feed. The metadata can identify a particular type or product or service and/or identify a particular company's product or service. The metadata can include other information as well, such as the content creator for the media feed, content distributor associated with this version of the media feed, details about the content of the media feed (name, date first aired, category, rating, etc.), author of the metadata, and others. In fact, the metadata can be configured with any details desired. Some example metadata associated with tagging the media feed and an interface for achieving the same are presented below with reference to the discussion of the FIG. 4. Additionally, some of the metadata may be prefabricated with the media feed when it is initially produced and/or years after it was originally produced. Still further, the metadata may be added, at least in part, dynamically as a live media feed is being broadcast using filtering agents that monitor the live media feed. Moreover, the metadata does not have to be embedded with the media feed, although in some cases it can be so integrated; that is, the metadata can be a separate file about the media feed that is time synched to the playing of the media feed. Any other situation can be used where markup of a media feed is achieved and that markup is customizable and identified as metadata; these other situations are intended to be alternatives to the processing presented herein and below. For example, it may be that the mobile device lacks a direct connection to the second device or a related device connected to the second device (such as a DVR, etc.) and the second device presents checkpoint codes, icons, or pictures while playing such that the user of the mobile device can select said corresponding codes, icons, or pictures on the mobile device and the advertising mobile app synchs with what is playing with the media feed.

According to an embodiment, at 121, the advertising mobile app scrolls the metadata (or some selective portion of the metadata) as a virtual catalogue on a display of the mobile device. So, in this case, the consumer/user watches the display of the mobile device and as the media feed plays on the different device (second device), time synched information for the products or services scroll on the display of the mobile device.

In an embodiment, at 122, the advertising mobile app filters the metadata from available metadata acquired with the media feed based on a profile for the user. So, the metadata is a subset of what is actually available to the advertising mobile app from the media feed; that subset defined by the user via a registered profile for the user. For example, maybe the user only wants to see information (subset of the metadata) for a media feed (television show) related to sporting goods or services; in such a case the user (via the profile) just sees such goods and services.

At 130, the advertising mobile app records comments received from the user with respect to one or more of the products and services. These comments can be clicks, answers to questions, instructions, or any action taken by the user with respect to a displayed product or service (it is noted that an action can be negative, such as when the user indicates he/she does not want to see anything like a particular product again).

In an embodiment, at 131, the advertising mobile app identifies a particular comment as a social media “like” indication for selective ones of the one or more products or services. So, again the user can issue a command saying update a social media site with my opinion that is product or service is agreeable or disagreeable to him/her.

In one situation, at 132, the advertising mobile app identifies a particular comment as a tag for later recall on behalf of the user. Here, the user may click a particular product or service so that later (when the user is ready) additional information for that clicked product or service can be presented on the mobile device for the user to investigate.

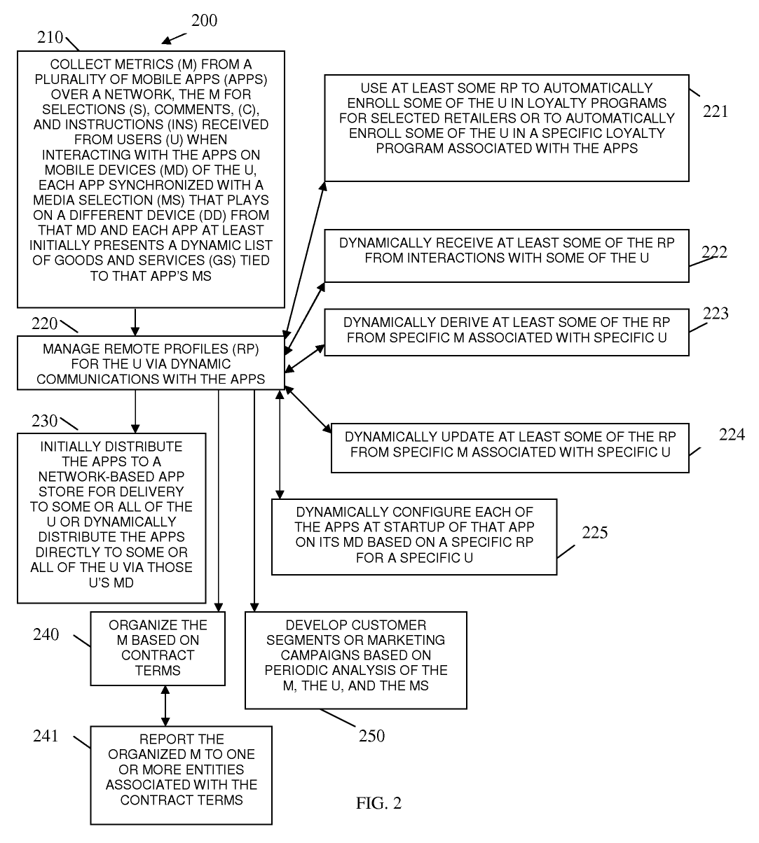

In yet another case, at 133, the advertising mobile app collects and remotely reports the comment with an identifier for the user and an identifier for the media feed. In other words, the user, the media feed, all the clicks, perhaps the user's profile, and any additional action taken by the user with respect to the products or services are reported to an advertising manager (such as the one discussed below with reference to the FIG. 2).

According to an embodiment, at 140, the advertising mobile app presents a basket of selected ones of the products or services tied to the comments at a conclusion of the media feed on the second device or when instructed by the user. So for example, the user may have clicked (made a form of a comment) on 5 specific products provided during playing of the media feed out of 50 products presented on the mobile device; when the media feed completes playing those 5 specific products are grouped and presented in an electronic basket to the user on the mobile device.

Continuing with the embodiment of 140 and at 141, the advertising mobile app receives a selection from the user for a particular product or a particular service identified in the basket. This is an indication that the user is interested in pursuing this particular item or in at least finding out additional information; such user interest can be noted as a comment and recorded for the item, the media feed, and the user.

Continuing with the embodiment of 141 and at 142, the advertising mobile app determines whether the selection for the item is unique or ubiquitously available by enterprises. In other words, is the item that user is interest in available at a wide range or retailers (ubiquitous) or only available by custom order from a particular retailer (unique).

Continuing with the embodiment of 142 and at 143, the advertising mobile app provides the user with an availability associated with the selection when it is unique and not presently available. This can occur when the selection is being advertised but is not released as of yet or when the selection has to be custom ordered, or demand is high and the retailer needs some time to make the selection.

Still continuing with the embodiment of 142 and at 144, the advertising mobile app locates particular enterprises in geographic proximity to the mobile device and lists those particular enterprises on the mobile device for the user when the selection is ubiquitously available. So, retailers offering the selection made by the user in the basket as presented on the mobile device are identified based on a geographic range between the location of the mobile device and those retailers.

Continuing with the embodiment of 144 and at 145, the advertising mobile app interacts with an interface of a selected enterprise that is selected from the particular enterprises. The selected enterprise identified by the user and the advertising mobile app then schedules a date and time for the user to visit the selected enterprise for purposes of trying out the selected item.

In an alternative situation, at 146, the advertising mobile app interacts with an interface of a selected enterprise that is selected from the particular enterprises. The selected enterprises are identified by the user and then the advertising mobile app assists the user in purchasing the selected item for pickup at the selected enterprise. Here, the advertising mobile app can facilitate a purchase of a product at a given enterprise and have it available for pickup.

The embodiments of 145 and 146 are particularly useful to brick-and-mortar stores that are struggling to compete with online retailers. One major benefit of brick-and-mortar stores is that the product is available for immediate pickup and there are no shipping expenses; so, utilizing online technology in a manner that promotes usage of brick-and-mortar stores may better improve competition and revitalize traditional brick-and-mortar stores.

According to an embodiment, at 150, the advertising mobile app interacts with the user to develop a profile that is remotely recorded. Here, the user makes selections about preferences in a question and answer dialogue to develop the profile. In an alternative embodiment, the advertising mobile app can monitor comments of the user over some preconfigured period of time and then automatically derive a profile on behalf of the user based on a history of interactions with the user.

In an embodiment, at 160, the advertising mobile app interacts with the user to enroll the user in a loyalty program. The loyalty program can be associated with the advertising mobile app or can be for a specific enterprise that is in partnership with the advertising mobile app, such that automated enrollment or assisted enrollment is achieved via the advertising mobile app.

FIG. 2 is a diagram of another method 200 for advertising, according to an example embodiment. The method 200 (hereinafter “advertising manager”) is implemented as instruction and programmed within memory and/or a non-transitory computer-readable (processor-readable) storage medium that executes on one or more processors of a server device; the processors of the server device are specifically configured to execute the advertising manager. The advertising manager is operational over a network; the network is wired, wireless, or a combination of wired and wireless.

Whereas the advertising app (the FIG. 1 above) describes processing associated with advertising from the perspective of the mobile device, the advertising manager describes processing associated with a server device. The advertising app and the advertising manager interact with one another in the manners discussed above and below.

At 210, the advertising manager collects metrics from a plurality of mobile apps over a network. The metrics are collected for comments, selections, and instructions received from users when interacting with the apps on mobile devices of the users. Each mobile app is synchronized with a media selection that plays on a different device from the mobile devices and each mobile app at least partially presents a dynamic list of goods and services that is tied to that mobile app's media selection.

The metrics identify a variety of information associated with the media selections, the users, and actions of the users for what is displayed on their mobile devices. This can include information about the media selection distributors, creators, and/or licensees. Moreover this can include information related to enterprises associated with marketing or selling the goods and services. Also, the metrics include information related to the users.

At 220, the advertising manager manages remote profiles for the users via dynamic communications with the mobile apps. So, the mobile apps are configured based on a particular user's profile. The profile can authorize automated actions and filter what is shown to the user via that user's mobile device.

According to an embodiment, at 221, the advertising manager uses at least some remote profiles to automatically enroll some of the users in loyalty programs for selected retailers or to automatically enroll some of the users in a specific loyalty program associated with the mobile apps. This scenario was discussed above with respect to the processing at 160 of the FIG. 1.

In an embodiment, at 222, the advertising manager dynamically receives at least some of the remote profiles from interactions with some of the users.

In another case, at 223, the advertising manager dynamically derives at least some of the remote profiles from specific metrics associated with a specific user.

According to an embodiment, at 224, the advertising manager dynamically updates at least some of the remote profiles from specific metrics associated with specific users. Here, as tastes or interests of the user changes over time and comments for goods and services change, the changes or trend can be reflected as an update to that user's profile.

In yet another case, at 225, the advertising manager dynamically configures each of the mobile apps at startup of that mobile app on its mobile device based on a specific remote profile for a specific user.

According to an embodiment, at 230, the advertising manager initially distributes the mobile apps to a network-based app store for delivery to some or all of the users or dynamically distributes the mobile apps directly to some or all of the users via those users' mobile devices. The app store can be related to any operating system, such as but not limited to, iOS, Android, Linus, Windows, UNIX, BlackBerry, and others.

In an embodiment, at 240, the advertising manager organizes the metrics based on contract terms. That is, the advertising manager can have relationships defined by contracts with enterprises and the metrics can be organized based on those terms to enforce, monitor, and manage the contracts.

Continuing with the embodiment of 240 and at 241, the advertising manager reports the organized metrics to one or more entities associated with the contract terms. This can be done for purposes remuneration or pursuant to reporting requirements of the contract terms and for other reasons.

According to an embodiment, at 250, the advertising manager develops customer segments or marketing campaigns based on periodic analysis of the metrics, the user, and the media selection. So, automated or semi-automated customer-relationship management (CRM) can be achieved, via analysis of the metrics.

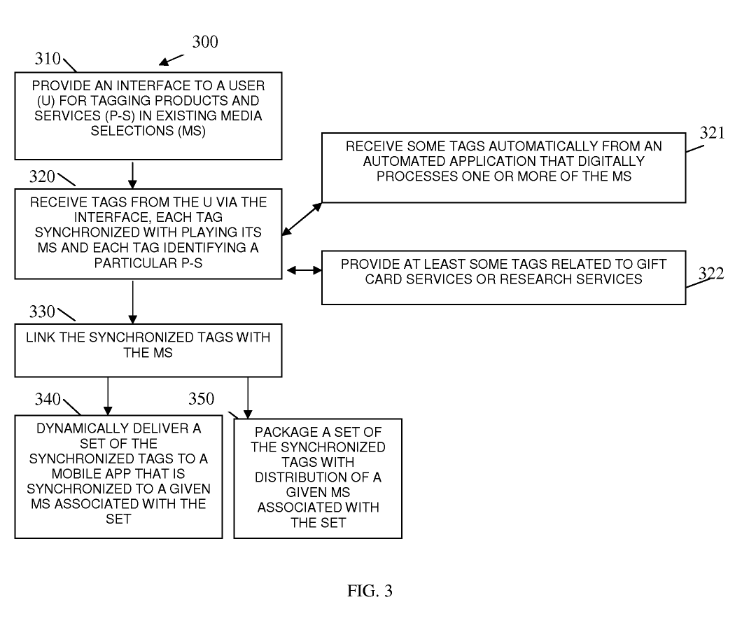

FIG. 3 is a diagram of yet another method 300 for advertising, according to an example embodiment. The method 300 (hereinafter “content enhancer”) is implemented as instruction and programmed within memory and/or a non-transitory computer-readable (processor-readable) storage medium that executes on one or more processors of a server device; the processors of the content enhancer are specifically configured to execute the content enhancer. The content enhancer is operational over a network; the network is wired, wireless, or a combination of wired and wireless.

Whereas the method 100 discusses the processing from the perspective of a mobile app of a user and the method 200 discusses the processing from the perspective of an advertising manager on a server, the processing of the content enhancer discusses an interface to enhance content or media selections/feeds with metadata that enable the processing of the methods 100 and 200. In this since, the content enhancer may be viewed as a tool provided to content distributors.

At 310, the content enhancer provides an interface to a user for tagging products and services in existing media selections. The user can interactively view a particular media selection and use the interface to tag (at specific scenes or time slices) products or services. The tags do not have to be for items specifically appearing in the media selection; rather, in some instances the tags can be related to an inferred meaning from a scene of the media selection. The tags can be created as needed and selected in other cases from a list of available tags.

At 320, the content enhancer receives tags from the user via the interface, each tag synchronized with playing its media selection. Moreover, each tag identifies a particular product or service or category for a product or service.

According to an embodiment, at 321, the content enhancer receives some tags automatically from an automated application that digitally processes one or more the media selections. Here, agents can analyze audio and/or video for template patters that are mapped to specific tags. So, some processing of the tags can be automated and need not be a semi-automated process with the user. In this scenario, the interface may include an Application Programming Interface (API) accessed automatically via calls by the agents.

In an embodiment, at 322, the content enhancer provides at least some tags related to gift card services or research services. So, tags can be used to identify or call retailers to allow the consumer to buy gift cards. Calls can be made to research services as well for providing education or reference information based on selections of the user.

At 330, the content enhancer links the synchronized tags with the media selection. This can be done via a third party, via a time offset from checkpoints, or via any other known mechanism where the customized and synchronized tags are linked to specific spots or ranges of scenes within the media selections.

According to an embodiment, at 340, the content enhancer dynamically delivers a set of synchronized tags to a mobile app that is synchronized to a given media selection associated with the set. So, the set is provided as a service when a media selection is identified by a mobile app.

In another case, at 350, the content enhancer packages a set of the synchronized tags with distribution of a given media selection associated with the set. Here, the set is integrated with the media selection or provided as a separate file with the media selection.

FIG. 4 is a diagram of an interactive advertising system 400, according to an example embodiment. The components of the interactive advertising system 400 reside in memory or in a non-transitory computer-readable medium as executable instructions that are processed on one or more processors of one or more devices. Moreover, the components are operational over a network; the network wired, wireless, or a combination of wired and wireless.

In an embodiment, the interactive advertising system 400 implements, inter alia, the advertising manager of the FIG. 2.

The interactive advertising system 400 includes an advertising manager 401.

The interactive advertising system 400 includes a server machine or a cloud processing environment having memory or non-transitory computer-readable storage media with the advertising manager 401. Processors of the server machine or the cloud processing environment are specifically configured to execute the advertising manager 401. Example processing associated with the advertising manager 401 was presented in detail above with respect to the method 200 of the FIG. 2.

The server having the advertising manager 401 or an entirely different server is configured to distribute an advertising app 402 to a mobile device of a consumer. Example processing associated with the advertising app 402 was discussed in detail above with reference to the FIG. 1 and the method 100.

In an embodiment, the advertising app 402 is available via an app server, such as via operating systems including iOS, Android, Mobile Windows, and others. In another case, as alluded to above, the advertising app 402 is distributed via the server and perhaps via the advertising manager 401.

Initially, the advertising app 402 is configured to synchronize with a media selection to display a dynamic list of goods and services related to playing the media on a different device from the mobile device. Additionally, the advertising app 402 is configured to receive comments from the consumer with respect to selective ones of those goods and services on the mobile device.

The advertising app 402 is configured to collect metrics on interactions with the consumer and configured to report those metrics back to the advertising manager 401.

According to an embodiment, the different device that plays the media selection is a digital sign, a television, and/or a multimedia device in communication with the mobile device having the advertising app 402

In an embodiment, the mobile device processing the advertising app is a phone, a tablet, and/or a laptop.

In one situation, the server having the advertising manager 401 is part of a cloud processing environment.

In another scenario, the advertising app 401 is configured to negotiate or to deliver offers from enterprises associated with the list. The offers are redeemable by the consumer with those enterprises.

Continuing with the prior embodiment and in some cases, the advertising app 402 is configured to report a purchase at a given enterprise for a given offer back to the advertising manager 401 as part of the metrics.

It is also noted that the advertising manager 401 can also be configured to manager, distribute, and/or provide the features discussed above with respect to the method 300 of the FIG. 3. In fact, in situations where the advertising app 401 (method 100 of the FIG. 1) is a web based application with remote processing; the advertising manager 401 can be configured to provide the processing associated with the advertising app 402

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A processor-implemented method programmed in memory or a non-transitory processor-readable medium and to execute on one or more processors of a mobile device configured to execute the method, comprising:
synchronizing a media feed to the mobile device, the media feed playing on a second device;
displaying metadata on the mobile device tied to the media feed, the metadata associated with products or services tied to the media feed; and
recording comments received from a user with respect to one or more of the products or the services.

2. The method of claim 1, wherein displaying further includes scrolling the metadata as a virtual catalogue on a display of the mobile device.

3. The method of claim 1, wherein display further includes filtering the metadata from available metadata acquired with the media feed based on a profile of the user.

4. The method of claim 1, wherein recording further includes identifying a particular comment as a social media like indication for selective ones of the one or more products or the services.

5. The method of claim 1, wherein recording further includes identifying a particular comment as a tag for later recall on behalf of the user.

6. The method of claim 1, wherein recording further includes collecting and remotely reporting the comments with an identifier for the user and an identifier for the media feed.

7. The method of claim 1 further comprising, presenting a basket of selected ones of the products or the services tied to the comments at a conclusion of the media feed on the second device or when instructed by the user.

8. The method of claim 7, wherein presenting further includes receiving a selection from the user for a particular good or a particular service identified in the basket.

9. The method of claim 8, wherein receiving further includes determining whether the selection is unique or ubiquitously available by enterprises.

10. The method of claim 9, wherein determining further includes providing the user with an availability associated with the selection when it is unique and not presently available.

11. The method of claim 9, wherein determining further includes locating particular enterprises in geographic proximity to the mobile device and listing those particular enterprises on the mobile device for the user when the selection is ubiquitously available.

12. The method of claim 11, wherein locating further includes interacting with an interface of a selected enterprise that is selected from the particular enterprises, the selected enterprise identified by the user, and scheduling a date and time for the user to visit the selected enterprise and try out the selection.

13. The method of claim 11, wherein locating further includes interacting with an interface of a selected enterprise that is selected from the particular enterprises, the selected enterprise identified by the user, and assisting the user in purchasing the selection for pickup at the selected enterprise.

14. The method of claim 1 further comprising, interacting with the user to develop a profile that is remotely recorded.

15. The method of claim 1 further comprising, interacting with the user to enroll the user in a loyalty program.

16. A processor-implemented method programmed in memory or a non-transitory processor-readable medium and to execute on one or more processors of a server device configured to execute the method, comprising:
collecting metrics from a plurality of mobile apps over a network, the metrics for selections, comments, and instructions received from users when interacting with the mobile apps on mobile devices of the users, each mobile app synchronized with a media selection that plays on a different device from that mobile device and each mobile app at least initially presenting a dynamic list of goods and services tied to that mobile app's media selection;
managing remote profiles for the users via dynamic communications with the mobile apps.

17. The method of claim 16 further comprising, initially distributing the mobile apps to a network-based app store for delivery to some or all of the users or dynamically distributing the mobile apps directly to some or all of the users via those users' mobile devices.

18. The method of claim 16 further comprising, organizing the metrics based on contract terms.

19. The method of claim 18 further comprising, reporting the organized metrics to one or more entities associated with the contract terms.

20. The method of claim 16 further comprising, developing customer segments or marketing campaigns based on periodic analysis of the metrics, the users, and the media selections.

21. The method of claim 16, wherein managing profiles further includes using at least some remote profiles to automatically enroll some of the users in loyalty programs for selected retailers or to automatically enroll some of the users in a specific loyalty program associated with the mobile apps.

22. The method of claim 16, wherein managing profiles further includes dynamically receiving at least some of the remote profiles from interactions with some of the users.

23. The method of claim 16, wherein managing profiles further includes dynamically deriving at least some of the remote profiles from specific metrics associated with specific users.

24. The method of claim 16, wherein managing profiles further includes dynamically updating at least some of the remote profiles from specific metrics associated with specific users.

25. The method of claim 16, wherein managing profiles further includes dynamically configuring each of the mobile apps at startup of that mobile app on its mobile device based on a specific remote profile for a specific user.

26. A processor-implemented method programmed in memory or a non-transitory processor-readable medium and to execute on one or more processors of a device configured to execute the method, comprising:
providing an interface to a user for tagging products and services in existing media selections;
receiving tags from the user via the interface, each tag synchronized with playing its media selection and each tag identifying a particular product or service; and
linking the synchronized tags with the media selections.

27. The method of claim 26 further comprising, dynamically delivering a set of the synchronized tags to a mobile app that is synchronized to a given media selection associated with the set.

28. The method of claim 26 further comprising, packaging a set of the synchronized tags with distribution of a given media selection associated with the set.

29. The method of claim 26, wherein receiving further includes receiving some tags automatically from an automated application that digitally processes one or more of the media selections.

30. The method of claim 26, wherein receiving further includes providing at least some tags related to gift card services or research services.

31. A system, comprising:
a server having memory configured with a advertising manager that executes on one or more processors of the server; and
the server or a different server configured to distribute an advertising app to a mobile device of a consumer;
wherein the advertising app is configured to synchronize with a media selection to display a dynamic list of goods and services related to playing the media on a different device from the mobile device and receive comments from the consumer with respect to selective ones of those goods and those services, and wherein the advertising app is configured to collect metrics on interactions with the consumer and report the metrics back to the advertising manager.

32. The system of claim 31, wherein different device is one of: a digital sign, a television, and a multimedia device in communication with the mobile device.

33. The system of claim 31, wherein the mobile device is one of: a phone, a tablet, and a laptop.

34. The system of claim 31, wherein the server is part of a cloud processing environment.

35. The system of claim 31, wherein the advertising app is configured to negotiate or to deliver offers from enterprises associated with the list, the offers redeemable by the consumer with those enterprises.

36. The system of claim 35, wherein the advertising app is configured to report a purchase at a given enterprise for a given offer back to the advertising manager as part of the metrics.
